(19) United States
(12) Patent Application Publication
(10) Pub. No.: US 2015/0257409 A1
(43) Pub. Date: Sep. 17, 2015

(54) Support Apparatus for Stick and Bagged Items

(71) Applicant: Kerry Jo Wilson, Webster, TX (US)

(72) Inventor: Kerry Jo Wilson, Webster, TX (US)

(21) Appl. No.: 14/206,994

(22) Filed: Mar. 12, 2014

(51) Int. Cl. A23G 7/00; F16M 13/02

(52) U.S. Cl. CPC A23G 7/0031; F16M 13/022

(57) ABSTRACT

What is provided is an apparatus for use in a decorative or edible arrangement, comprising a stem portion having an upper end and a lower end, and a holder attached to the upper end of the stem portion. What is further provided is apparatus for use in a decorative or edible arrangement, comprising a stem portion having an upper end and a lower end, and a plurality of holders attached to the upper end of the stem portion.

### CROSS-REFERENCE TO RELATED APPLICATIONS

This application claims priority to U.S. Provisional Patent Application No. 61/777,301

### STATEMENT REGARDING FEDERALLY SPONSORED RESEARCH OR DEVELOPMENT

Not applicable

### REFERENCE TO A “MICROFICHE APPENDIX”

Not applicable

### ATTORNEY DOCKET NUMBER

Wilson-001

### FIELD OF THE INVENTION

This invention relates to a device for use in decorative and/or edible arrangements. More particularly, the present invention relates to a device to be used in confectionery arrangements.

### BACKGROUND OF THE INVENTION

Creative flexibility is critical in the design and presentation of decorative and edible arrangements. Millions of dollars are spent each year on sending arrangements to friends, colleagues, loved ones, and business contacts. At the present time, decorative items, including food items such as cake pops or cookies on a stick, are presented in arrangements with the stick penetrated into a base such as wood or acrylic with pre-drilled holes, Styrofoam, or floral foam, limiting the height placement and design potential of the arrangement or display. Other preformed support structures prevent a user from designing an arrangement in different shapes. In addition to limiting the creative flexibility of the arrangement, the item, such as a cake pop or cookie, can become broken or damaged upon removal. Accordingly, what is needed is an apparatus that allows for maximum creative flexibility while preventing damage during the removal of the pieces of the arrangement.

While certain novel features of this invention shown and described below are pointed out in the annexed claims, the invention is not intended to be limited to the details specified, since a person of ordinary skill in the relevant art will understand that various omissions, modifications, substitutions and changes in the forms and details of the device illustrated and in its operation may be made without departing in any way from the spirit of the present invention. No feature of the invention is critical or essential unless it is expressly stated as being “critical” or “essential.”

### SUMMARY OF INVENTION

The apparatus of the present invention solves the problems confronted in the art in a simple and straightforward manner. What is provided is an apparatus for use in an arrangement, comprising a stem portion having an upper end and a lower end, and a holder attached to the upper end of the stem portion. What is further provided is apparatus for use in an arrangement, comprising a stem portion having an upper end and a lower end, and a plurality of holders attached to the upper end of the stem portion.

### BRIEF DESCRIPTION OF THE DRAWINGS

The teachings of the present invention can be readily understood by considering the following detailed description in conjunction with the accompanying drawings, in which:

FIG. 1 illustrates a front view of a support apparatus for stick and bagged items.

FIG. 2 illustrates a front view of a support apparatus with multiple holders for stick and bagged items.

FIG. 3 illustrates a front view of a support apparatus with a hook for stick and bagged items.

FIG. 4 illustrates a front view of two support apparatuses with different stem widths.

FIG. 5 illustrates a front view of multiple support apparatuses inserted into a base.

To facilitate understanding, identical reference numerals have been used where possible, to designate identical elements that are common to the figures.

### DETAILED DESCRIPTION OF THE INVENTION

Detailed descriptions of one or more preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in any appropriate system, structure or manner.

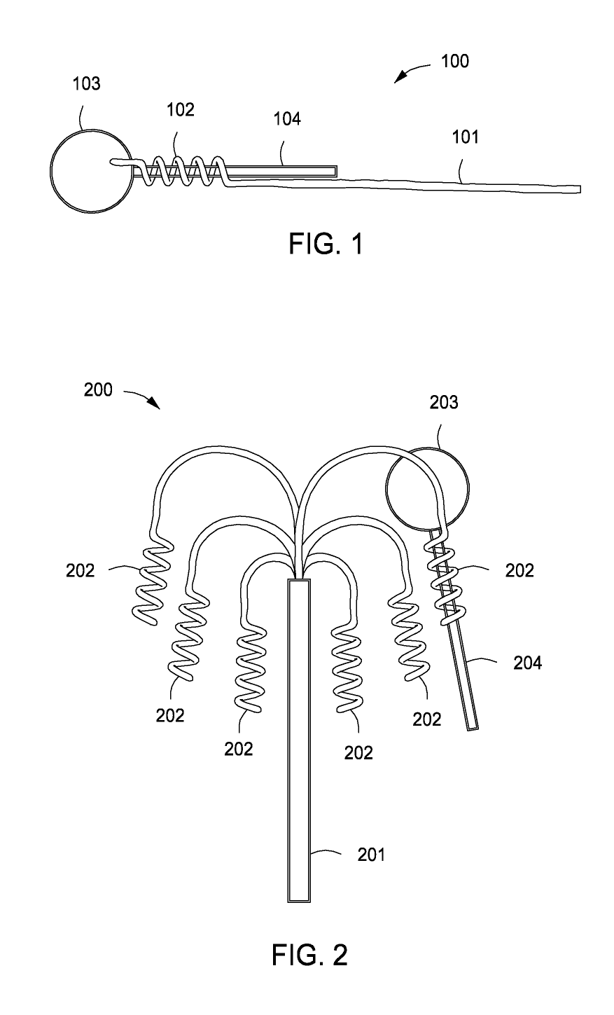

FIG. 1 is a front view of a support apparatus for stick and bagged items 100 in accordance with certain aspects of the present disclosure. FIG. 1 shows a stem 101 having a holder 102 attached to an upper end of the stem. The stem may be made from a malleable material, such as wire, or a rigid material, such as plastic, for example. In the preferred embodiment, the holder 102 may be a corkscrew formed from the stem 101, for example. In alternative embodiments, the holder 102 may be any hollow cylindrical apparatus configured to receive a stick. FIG. 1 further shows a stick 104 with an edible portion 103 attached to an upper end of the stick. The stick 104 is inserted into an inner cavity of the holder 102. In the preferred embodiment, the edible portion 103 may be a cookie or a cake pop. The support apparatus 100 provides multiple advantages over prior art. First, the holder portion 102 provides for easy insertion or removal of a stick item. Inserting the stick 104 directly into a base causes friction and may lead to breaking the edible portion 103. Additionally, the stem 101 may be bent to allow for design flexibility when it is made of a malleable material. A lower end of the stem 101 may be inserted into a base, such as foam, for example, as part of a decorative or edible arrangement.

FIG. 2 is a front view of a support apparatus for multiple stick and bagged items 200 in accordance with certain aspects of the present disclosure. FIG. 2 shows a stem 201 with a plurality of holders 202 attached to an upper end of the stem. In the preferred embodiment, the holders 202 may be corkscrews formed from the stem 201, for example. The stem 201 may be made from a multiple twisted elements, for example. In certain embodiments, the stem 201 and holders 202 may be made from a malleable material, for example, allowing flexibility of the holders. A user may bend the holders 202 in any direction, such as a downward direction as shown in FIG. 2. FIG. 2 further shows an edible portion 203 attached to a stick 204. The stick 204 is inserted into an inner cavity of the holder 202. The embodiment shown in FIG. 2 provides several advantages over the prior art. First, only a single stem 201 needs to be inserted into a base. This configuration also allows a user to make designs intended for a vase. Additionally, a user may selectively bend one or more of the holders 202 into an aesthetically pleasing configuration.

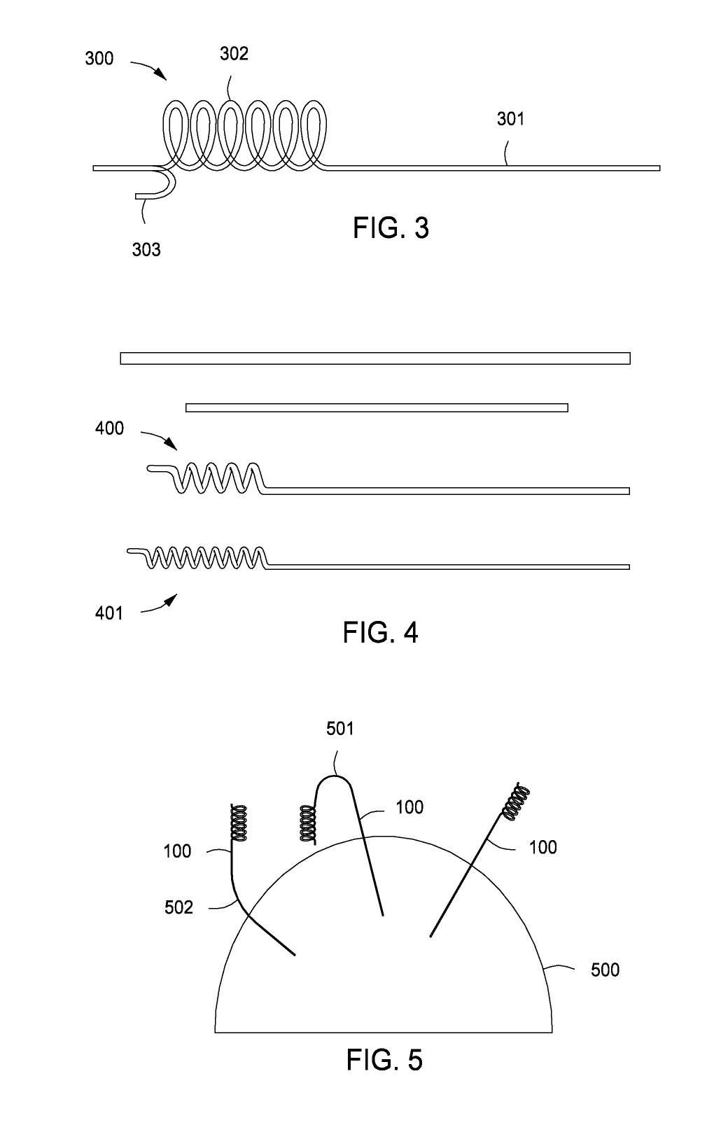

FIG. 3 is a front view of a support apparatus for multiple stick and bagged items 300 in accordance with certain aspects of the present disclosure. FIG. 3 shows a stem 301 having a holder 302 attached to an upper end of the stem. A support element 303 is attached to an upper end of the holder 302. The support element 303 is configured to support bagged items that may not necessarily have sticks. While the support 303 is shown as a hook in FIG. 3, a person with ordinary skill will appreciate that other mechanisms, such as clips and pins, for example, may be used in alternative embodiments. In certain embodiments, the holder 302 may be used to support small bottles, such as a miniature alcohol bottles.

FIG. 4 is a front view of two support apparatuses for multiple stick and bagged items in accordance with certain aspects of the present disclosure. Support apparatus 400 is shown with a relatively thick diameter. Support apparatus 401 is shown with a relatively thin diameter. Items included in decorative and edible arrangements have varying weights and often are seated atop sticks with varying diameters. Support apparatuses may bend and twist under the weight of a sick or bagged item. An increased diameter provides a more sturdy support apparatus for a heavier item. Further, a user may want to coat the stem of a support apparatus with a product that will increase friction between the stem and the base to prevent undesired movement. Rubber and powder coatings may be appropriate, for example.

FIG. 5 is a front view of a plurality of support apparatuses for multiple stick and bagged items 100 inserted into a base 500 in accordance with certain aspects of the present disclosure. FIG. 5 shows support apparatuses 100 inserted into varying locations on base 500. A user may select where to insert the support apparatus 100 into the base 500, providing an increased amount of design flexibility. FIG. 5 further shows bends 501 and 502, which allows the user to choose the direction that a stick or bagged item will point.

All measurements disclosed herein are at standard temperature and pressure, at sea level on Earth, unless indicated otherwise. All materials used or intended to be used in a human being are biocompatible, unless indicated otherwise.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The following is a list of reference numerals:

LIST OF REFERENCE NUMERALS

| (Part No.) | (Description) |
|---|---|
| 100 | Support apparatus for stick and bagged items |
| 101 | Stem |
| 102 | Holder |
| 103 | Edible portion |
| 104 | Stick |
| 200 | Support apparatus for multiple stick and bagged items |
| 201 | Stem |
| 202 | Holders |
| 203 | Edible portion |
| 204 | Stick |
| 300 | Support apparatus for stick and bagged items |
| 301 | Stick |
| 302 | Holder |
| 303 | Support Element |
| 400 | Thick diameter support apparatus for stick and bagged items |
| 401 | Thin diameter support apparatus for stick and bagged items |
| 500 | Base |
| 501 | Bend |
| 502 | Bend |

What is claimed is:

1. An apparatus for use in an arrangement, comprising:
a stem portion having an upper end and a lower end; and
a holder attached to the upper end of the stem portion.

2. The apparatus of claim 1, wherein the holder is configured to hold a stick item.

3. The apparatus of claim 1, wherein the holder is configured to hold a bagged item.

4. The apparatus of claim 1, wherein the holder is configured to hold a bottle.

5. The apparatus of claim 1, wherein the holder is a corkscrew.

6. The apparatus of claim 1, wherein the stem is made from a malleable material.

7. The apparatus of claim 1, wherein the stem is made from a rigid material.

8. The apparatus of claim 1, wherein the stem is coated.

9. The apparatus of claim 1, wherein a support element is attached to an upper portion of the holder.

10. An apparatus for use in an arrangement, comprising:
a stem portion having an upper end and a lower end; and
a plurality of holders attached to the upper end of the stem portion.

11. The apparatus of claim 10, wherein one or more of the holders are configured to hold stick items.

12. The apparatus of claim 10 wherein one ore more of the holders are configured to hold bagged items.

13. The apparatus of claim 10, wherein one ore more of the holders are configured to hold a bottle.

14. The apparatus of claim 10, wherein one or more of the holders are corkscrews.

15. The apparatus of claim 10, wherein the stem is made from a malleable material.

16. The apparatus of claim 10, wherein the stem is made from a rigid material.

17. The apparatus of claim 10, wherein the stem is coated.

18. The apparatus of claim 10, wherein support elements are attached to upper portions of the holders.
